(19) United States
(12) Patent Application Publication
(10) Pub. No.: US 2021/0276773 A1
(43) Pub. Date: Sep. 9, 2021

(54) PEELABLE DOUBLE-SIDED ADHESIVE CONNECTOR

(71) Applicant: FELSUMA, LLC, Somerville, MA (US)

(72) Inventor: Stephen Iwuc, Cumberland, RI (US)

(21) Appl. No.: 16/464,522

(22) PCT Filed: Nov. 29, 2017
(86) PCT No.: PCT/US17/63598

§ 371 Date: May 28, 2019

Related U.S. Application Data
(60) Provisional application No. 62/427,623, filed on Nov. 29, 2016.

(51) Int. Cl. B65D 63/10

(52) U.S. Cl. CPC B65D 63/1009; B65D 2313/08

(57) ABSTRACT

A connector for coupling an object to a substrate has a first flexible member coupled with a second flexible member. The first and second flexible members have corresponding first and second upper regions, and first and second lower region that define first and second intermediate regions. The first upper region is coupled with the second upper region, while the first lower region is coupled with the second lower region. Through this coupling, the first intermediate region is movable relative to the second intermediate region. To minimize damage to the substrate during removal, the first and second flexible members are configured so that application of a normal force, when coupled with the substrate, causes at least the first upper region to form a critical angle sufficient to peel the connector from the substrate. The normal force is generally normal to and in a direction away from the substrate.

### PRIORITY

This patent application claims priority from provisional U.S. patent application No. 62/427,623, filed Nov. 29, 2016, entitled, “PEELABLE CONNECTOR,” and naming Stephen Iwuc as inventor, the disclosure of which is incorporated herein, in its entirety, by reference.

### FIELD OF THE INVENTION

Illustrative embodiments of the invention generally relate to connectors and, more particularly, illustrative embodiments of the invention relate to connectors for connecting an object to a substrate.

### BACKGROUND OF THE INVENTION

Various fastening systems couple objects (e.g., a picture frame) to an underlying substrate (e.g., the surface of a wall) using nails, screws, glues, two-part epoxies, adhesive tapes (e.g., double sided tapes), staples, and VELCRO®. Each of these different fastening systems typically permanently or temporarily fastens to its desired substrate. Undesirably, however, these systems may damage the underlying substrate. For example, many adhesives adhere to the underlying substrate so strongly that, when their underlying system is removed, they undesirably remove a portion of the substrate.

### SUMMARY OF VARIOUS EMBODIMENTS

In accordance with one embodiment of the invention, a connector for coupling an object to a substrate has a first flexible member coupled with a second flexible member. The first flexible member has a first upper region and a first lower region defining a first intermediate region. In a corresponding manner, the second flexible member has a second upper region and a second lower region defining a second intermediate region. The first upper region is coupled with the second upper region, while the first lower region is coupled with the second lower region. Through this coupling, the first intermediate region is movable relative to the second intermediate region. To minimize damage to the substrate during removal, the first and second flexible members are configured so that application of a normal force, when coupled with the substrate, causes at least the first upper region to form a critical angle sufficient to peel the connector from the substrate. The normal force is generally normal to and in a direction away from the substrate.

In some embodiments, the first upper region and the first lower region include a material configured not to adhere with the substrate. Moreover, the first intermediate region has a first inner surface and, in a similar manner, the second intermediate region has a second inner surface. The first inner surface is configured not to adhere with the second inner surface. The first inner surface and/or the second inner surface also may have a stiffening material

The first flexible member may include a foam layer at least partly coated with a layer of elastomeric adhesive. In a similar manner, the first intermediate region may have a first outer surface with a layer of elastomeric adhesive configured to removably couple with the substrate or an object. That elastomeric adhesive is configured to cause the first outer surface to peel from the substrate at an angle equal to or greater than the critical angle.

The connector also may have a permanent adhesive coupling the first upper region with the second upper region. Moreover, the flexible members preferably are configured so that application of the noted normal force causes the first intermediate region to separate from the second intermediate region.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a perspective view of the connector configured in accordance with illustrative embodiments of the invention.

FIG. 2 schematically shows a generic side view of the connector of FIG. 1 with a portion of its flexible members spaced apart.

FIG. 3 schematically shows a cross-sectional view of the connector of FIG. 1.

FIG. 4A schematically shows a side view of the connector of FIG. 1 coupled between a substrate and an object before receiving a force normal to the substrate.

FIG. 4B schematically shows a side view of the connector of FIG. 1 coupled between a substrate and an object while receiving a force normal to the substrate.

### DESCRIPTION OF ILLUSTRATIVE EMBODIMENTS

In illustrative embodiments, a connector is configured to peel away from a substrate upon receipt of a sufficient force generally normal to the substrate. To that end, the connector includes a pair of flexible members with coupled fixed portions, and free portions that can move relative to each other. Application of the noted force causes at least one of the flexible members to form a critical angle sufficient to peel the connector from the substrate. Preferably, the connector does not damage the substrate as it is peeled. Details of illustrative embodiments are discussed below.

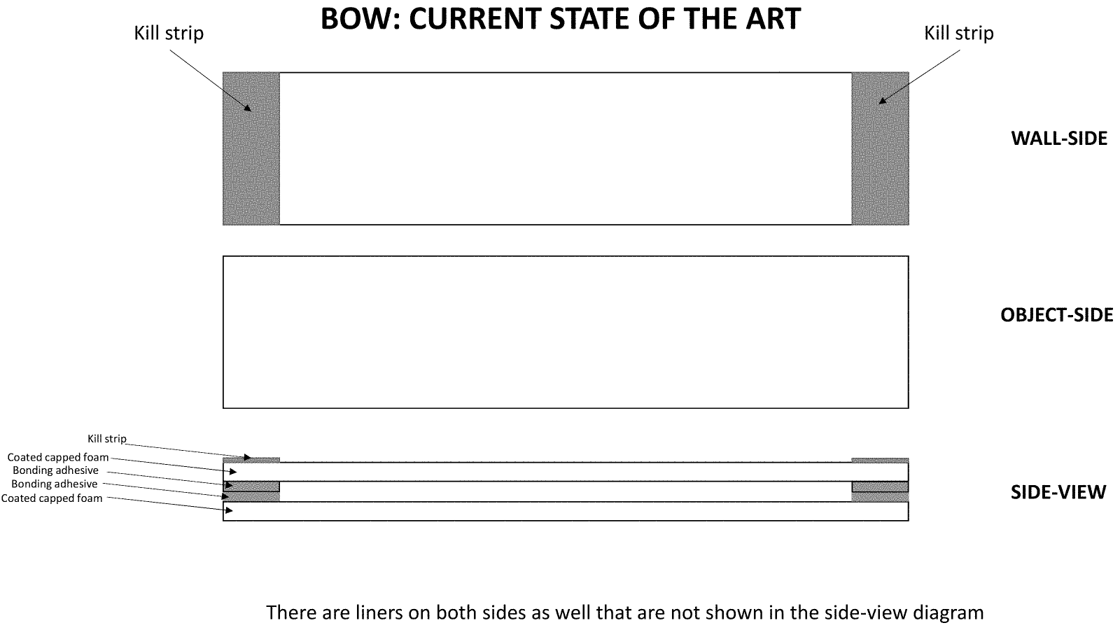

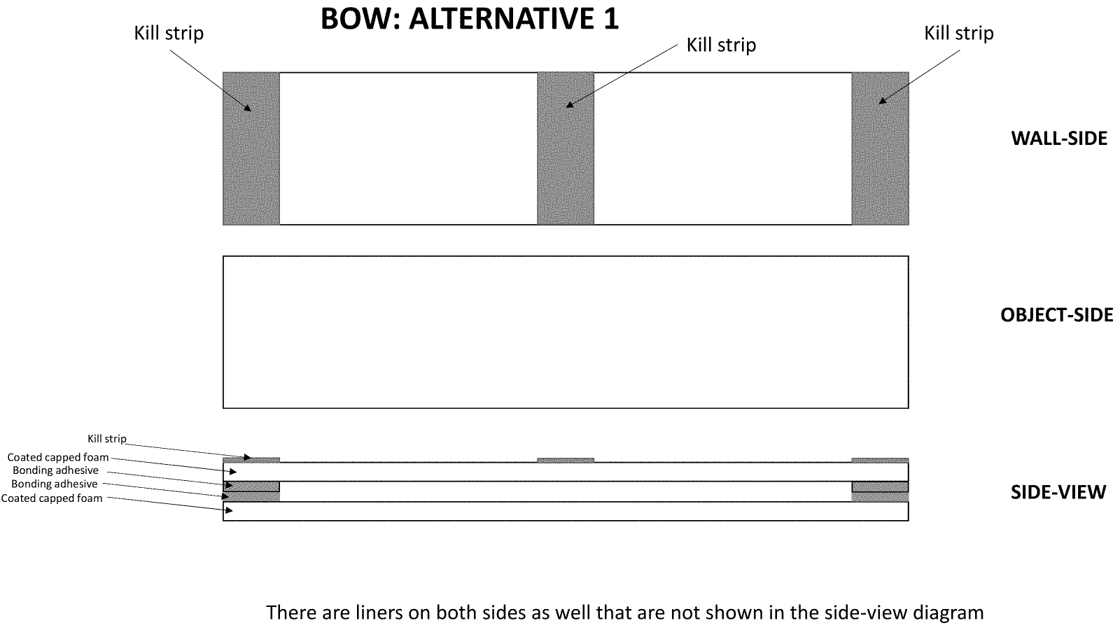

FIG. 1 schematically shows a perspective view of a connector 10 configured in accordance with illustrative embodiments of the invention. This view of FIG. 1 shows the connector 10 in its unactuated/unused orientation—i.e., when not subjected to forces. Thus, the natural flexibility and elasticity of the connector 10 maintains it in this configuration when unactuated. FIG. 2 schematically shows a generic side view of the connector 10 of FIG. 1 with portions of it spaced apart. Accordingly, this view of FIG. 2 shows the connector 10 in an actuated orientation; i.e., receiving a force or otherwise held in this position.

As shown in these two initial figures, the connector 10 of this embodiment includes two elongated flexible members 12 coupled together at their two end regions 14. Specifically, each flexible member 12 includes an upper and a lower end region 14. Note that in this description, reference to “upper,” “lower,” and similar designations is for convenience only to distinguish between the two noted portions from the perspective of FIG. 1. Indeed, those two regions are not necessarily higher or lower from the perspective of FIG. 2, although still designated using “upper” and “lower” designations. Those designations thus are not intended to imply specific upper and lower relationships for all embodiments.

Thus, as shown more clearly in FIG. 2, the two upper end regions 14 are connected together while, in a corresponding manner, the two lower end regions 14 also are connected together. Those skilled in the art can couple the two members in this manner using any of a variety of techniques. For example, a pressure sensitive adhesive or bonding agent (identified as “adhesive agents 16”) sufficient to withstand anticipated forces should suffice. Among other things, those adhesive agents 16 may include heat seal films (polyolefin, polyurethane, acrylic, acrylic hybrids, natural and synthetic rubber and polyolefin copolymers), mechanical bonds (staples, stitching), and/or other adhesives, such as pressure sensitive and structural adhesives (e.g. two part epoxies). Some embodiments use HF, ultrasonic (among other forms of) plastic welding, or laminating liquid adhesives.

Other embodiments may connect the end regions 14 together using non-adhesive techniques, such as staples or a specialized fabric weave. For example, non-adhesive techniques may connect the end regions 14, or both non-adhesive techniques augmented by an adhesive agent 16.

As shown, the upper and lower end regions 14 of each flexible member 12 may be considered to form an intermediate region 18. As shown in FIG. 2, the adhesive agents 16 preferably extends from some area proximate to the far end of the flexible member 12 (e.g., at the edge or slightly inward from the edge) at least up to the intermediate region 18. In other embodiments, however, the adhesive agents 16 extend to a point short of the intermediate regions 18.

Unlike the upper and lower end regions 14 of the two flexible members 12, however, the two intermediate regions 18 of the flexible members 12 are free to move relative to each other. Accordingly, as discussed in greater detail below, the inner surfaces of the intermediate regions 18 each are configured to not couple together when they abut/contact each other. To that end, illustrative embodiments treat those inner surfaces with a material or surface treatment that is non-adhering. Other embodiments may form the flexible members 12 with a material that is non-adhering to itself.

In contrast, the outside surfaces of the intermediate regions 18 preferably are adhering—i.e., they are treated with adhesive or other adherent material, or formed from an adhering material. Accordingly, the intermediate regions 18 preferably adhere to other objects, such as a substrate (e.g., a wall) and an object (e.g., a picture frame). As discussed in greater detail below, these adhesives preferably are formulated and selected to cooperate with the flexible members 12 to facilitate easy removal of the connector 10 with minimal damage to the substrate.

In accordance with illustrative embodiments of the invention, the outer surfaces of the upper and lower end regions 14 of each flexible member 12 preferably are configured to be non-adhering to anticipated substrates and objects. For example, those surfaces may have a layer of non-adhering material or other treatment having an outer surface that does not readily couple with anticipated substrates and objects. Alternatively, those surfaces may be formed from a material that is non-adhering. Accordingly, the intermediate region 18, with its adhesive, preferably provides the sufficient adhering force between the object and the substrate.

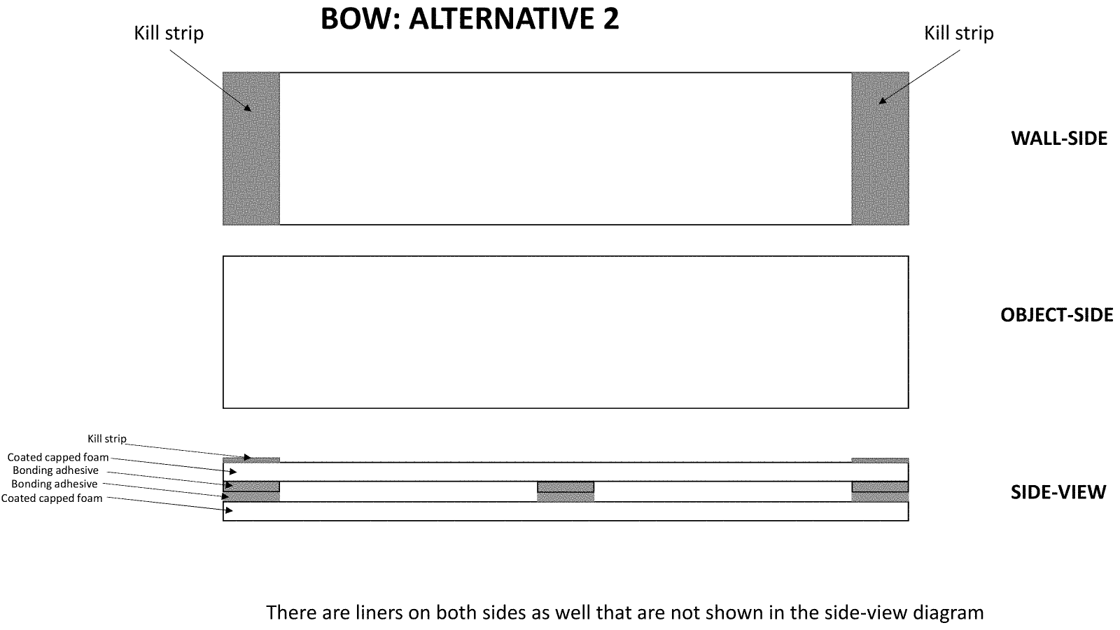

FIG. 3 schematically shows a cross-sectional view of the connector 10 of FIG. 1 in accordance with illustrative embodiments of the invention. This view shows more details of the connector layers than those shown in FIGS. 1 and 2. Specifically, this figure shows a top flexible member 12 with its various layers coupled to a bottom flexible member 12 with its various and corresponding layers. As shown, the prior noted adhesive/coupling adhesive agent 16 at the upper and lower end regions 14 couples those end regions 14 together. This coupling preferably is substantially permanent in that it should provide sufficient adhering force absent unusual uses or forces applied to it. For example, the adhesive agent 16 may be rated to withstand a prescribed amount of force before forcibly permitting the flexible members 12 to separate at the point of connection. This force should be substantially greater than forces anticipated during use. Moreover, using a tool or unusually forceful means, such as a knife, to physically separate the flexible members 12 at the permanently coupled upper and lower end regions 14 also does not diminish the fact that the coupling material creates a permanent connection.

In this embodiment, each flexible member 12 is formed from a layer of elastomeric material, such as foam (“foam layer 20”), having an outside surface coated or coupled with a layer of adhesive (“adhesive layer 22”). In illustrative embodiments, the adhesive layer 22 is selected so the connector 10 no more than minimally damages the underlying substrate (e.g., no damage) when it is removed from the substrate. Among other things, the adhesive layer 22 may include any of a wide variety of materials, such as acrylic, silicone, natural and synthetic rubber, urethane adhesives including pressure sensitive adhesives, removable adhesives such as pressure sensitive adhesives, liquid silicone rubbers, styrenic block copolymers (SBS, SIS, SIBS, SEBS, SEPS, HSFC, H-SEPS, etc.), and thiol-enes. Polymers with sufficient tack adhere to a substrate balanced with enough cohesive strength to support the desired load.

In a corresponding manner, the foam layer 20 may include any of a wide variety of materials. Among others, those materials may include polymeric and metalized films, stiff woven and non-woven synthetic and/or natural fiber fabrics, composites/laminates of polymers, fabric and foils, oriented and/or non-oriented polymeric films, silicone, urethane, and other polyolefin foams. Some embodiments may use one or more of the noted materials rather than the combination of the foam layer 20 and the below noted stiffening layer 24. Rather than using the foam and adhesive layers 20 and 22, some embodiments may use a material that has the functionality of layers 20 and 22.

As shown in the figures, the foam layer 20 of each flexible member 12 has an inner surface. As noted above, this inner surface preferably does not adhere to the inner surface of the other flexible member 12 against which it rests. Accordingly, as noted above, for each flexible member 12, illustrative embodiments treat the inner surface of the foam to ensure that it does not adhere to the other flexible member 12. In this embodiment, the inner surface of each flexible member 12 is coated with or coupled to a non-adhering stiffening layer 24. Some skilled in the art may refer to the combination of layers 20 and 24 as “capped foam”—e.g., the foam layer 20 with a film (e.g., an extruded film), such as layer 24.

Specifically, in illustrative embodiments, this non-adhering stiffening layer 24 has a prescribed stiffness that more evenly distributes longitudinal forces when adhered to a substrate. To that end, the non-adhering stiffening layer 24 preferably has a higher stiffness than that of the combination of layers 20 and 22. For example, in preferred embodiments, the non-adhering layer is formed from polyolefin. Other embodiments, however, may form the non-adhering layer from one or more of a variety of other materials, such as foils, polymeric sheet material, and thermoplastic polymers (e.g., applied as hot liquid and more rigid when cooled).

Some embodiments do not have this stiffening layer 24. Instead, those embodiments may configure the stiffness of the other layers to have the requisite stiffness requirement (and other qualities, such as non-adherence) of the application. As noted above, the outer surfaces of the upper and lower end regions 14 of each flexible member 12 preferably are configured to be non-adhering to anticipated substrates and objects. In this embodiment, the upper and lower end regions 14 of the adhesive layer 22 (on the foam layer 20) are treated to substantially eliminate adherence to the underlying substrate. In preferred embodiments, a polymeric film end region layer 26 adhered to these regions may suffice. As shown in FIGS. 1-3, this end region layer 26 preferably extends from some area proximate to the far end of the flexible member 12 (e.g., at the edge or slightly inward from the edge) at least up to the intermediate region 18. In addition to or instead of a polymeric film, the end region layer 26 may be formed from one or more of the following:
Thin film (PE, PET, EVA, PU, etc.),
Powder (e.g., Talc),

Alternatively, some embodiments may subject the upper and lower end regions 14 to a process that effectively removes significant adherence qualities. For example, after masking off the relevant regions (e.g., the intermediate region), some embodiments may UV cure the end regions 14. Still other embodiments may zone coat the end regions 14, and/or add blooming agents, such as waxes, amides, or surface treatment with release agents (e.g., carbamates).

It should be noted that although the discussion above refers to single layers, some embodiments may form each of the layers using multiple layers of materials. Moreover, those skilled in the art can select the appropriate materials for each of the layers as a function of the anticipated use of the connector 10. For example, certain connectors 10 may be used in applications to secure light objects (e.g., under 1 pound) to a prescribed family of substrates (e.g., drywall). As another example, however, certain connectors 10 may be used in applications to secure heavier objects (e.g., between 5 and 10 pounds) to a different family of substrates (e.g., wallpapered walls). Those skilled in the art may tune the materials to operate best for the application in which they are intended to be used.

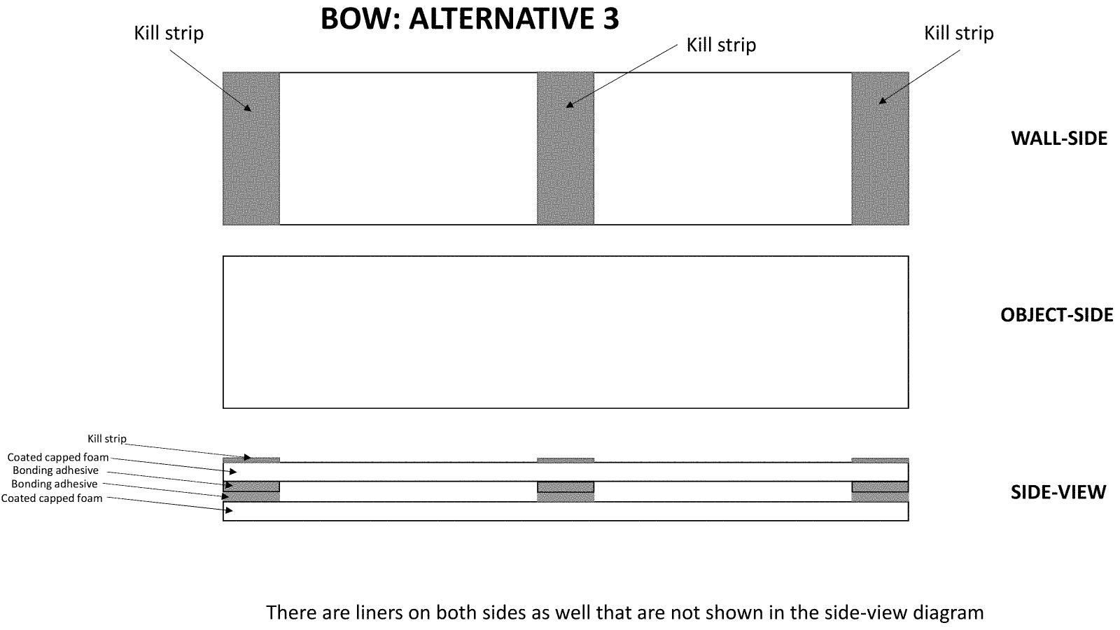

FIGS. 4A and 4B schematically illustrate one use of the connector 10 in accordance with illustrative embodiments of the invention. Specifically, FIG. 4A schematically shows the connector 10 securing an object 28 to a substrate 30 above a floor 32. For example, the object 28 may be a picture frame, while the substrate 30 may be a wall formed from drywall or sheetrock. As shown in FIG. 4A, the connector 10 normally receives and distributes the downwardly directed sheer force produced by the weight of the object 28. Specifically, the stiffening layer 24 at least in part preferably distributes that force within the connector 10 and, to some extent, to the substrate 30. In illustrative embodiments, the connector 10 may secure the object 28 to the wall for some period of time, such as seconds, minutes, hours, days, weeks, months, or years. At some point, however, a user may choose to remove the object 28 from the substrate 30. For example, the user may want to reorient the object 28 on the substrate 30, or simply remove the object 28 from the wall without reconnecting it to the substrate 30. To that end, FIG. 4B schematically shows the connector 10 and object 28 receiving a force “N” generally normal to the substrate 30. In preferred embodiments, this force N has a significant, predominant amount of force that is generally normal to the substrate 30. For example, a person may grasp the top and bottom ends of the object 28, but pull with a non-uniform force at each end. Despite this non-uniform force at each end, it may be considered to produce the generally normal force N, relative to the substrate 30, as it is predominantly normal to the substrate 30.

This force N thus effectively actuates the connector 10 to change its state. Specifically, after initially receiving the force N, the intermediate region 18 of the flexible member 12 contacting the object 28 begins moving in the direction of the force N. Even though FIG. 4B shows it as being uniform, this movement may be non-uniform to some extent about the intermediate region 18. In contrast, the intermediate region 18 of the flexible member 12 coupled to the substrate 30 remains substantially immovable relative to the substrate 30 up to a certain separation point/time. Accordingly, the intermediate regions 18 move relative to each other upon receipt of this generally normal force N.

In addition to movement of the intermediate region 18, the end regions 14 of the connector 10/flexible members 12 also begin to move away from the substrate 30 together until they also reach this noted separation point/time. Specifically, up to and at the separation point/time, the intersection of the end regions 14 and the intermediate regions 18 of the flexible member 12 on the substrate 30 forms a front with the substrate 30. That front defines an angle A between the flexible member 12 and the substrate 30. When that angle A reaches a prescribed minimum value, the intermediate region 18 begins to peel off of the substrate 30. Specifically, when that angle A reaches the prescribed minimum value, a continued nonplanar force applied to the connector 10 lifts the connector 10 from the substrate 30. That angle A may be referred to as the “critical angle A.”

Accordingly, application of this normal force to the connector 10 produces a corresponding peeling force that is different than that of the generally normal force. Application of the generally normal force therefore effectively produces a different force that peels the connector 10 from the substrate 30.

Illustrative embodiments also may add an easily removable release liner (not shown) that prevents the connector 10 from connecting with its packaging or other connectors 10 during distribution and storage.

Indeed, those skilled in the art may apply principals of various embodiments in a number of different manners. For example, the two flexible members 12 may have the same shape and size, such as those shown in the figures. Alternatively, the two flexible members 12 may have different shapes and sizes. For example, one of the flexible members 12 may have a square shape, while the other flexible member 12 may have a rectangular shape. The longest dimension of the rectangular flexible member 12 may be the same as the length of one side of the square flexible member 12.

Unlike the embodiments shown in FIGS. 1-4B, some embodiments do not form the connector 10 with substantially mirror image flexible members 12. For example, some embodiments may include the polymeric film end region layer 26 on the end regions 14 of only one of the flexible members 12. In that case, indicia on the connector 10 itself or other instructions may advise the user to apply the side of the connector 10 having the polymeric film against the substrate 30 for easy removal from the substrate 30.

Although the above discussion discloses various exemplary embodiments of the invention, it should be apparent that those skilled in the art can make various modifications that will achieve some of the advantages of the invention without departing from the true scope of the invention.

What is claimed is:

1. A connector for coupling an object to a substrate, the connector comprising:
a first flexible member having a first upper region and a first lower region defining a first intermediate region;
a second flexible member having a second upper region and a second lower region defining a second intermediate region;
the first upper region being coupled with the second upper region,
the first lower region being coupled with the second lower region,
the first intermediate region being movable relative to the second intermediate region,
the first and second flexible members being configured so that application of a normal force, when coupled with the substrate, causes at least the first upper region to form a critical angle sufficient to peel the connector from the substrate, the normal force being generally normal to and in a direction away from the substrate.

2. The connector of claim 1 wherein the first upper region and the first lower region include a material configured not to adhere with the substrate.

3. The connector of claim 1 wherein the first intermediate region has a first inner surface and the second intermediate region has a second inner surface, the first inner surface being configured not to adhere with the second inner surface.

4. The connector of claim 1 wherein the first intermediate region has a first inner surface and the second intermediate region has a second inner surface, the first inner surface having a stiffening material.

5. The connector of claim 1 wherein the first flexible member includes a foam layer at least partly coated with a layer of elastomeric adhesive.

6. The connector of claim 1 wherein the first intermediate region has a first outer surface having a layer of elastomeric adhesive configured to removably couple with the substrate or an object, the elastomeric adhesive being configured to cause the first outer surface to peel from the substrate at an angle equal to or greater than the critical angle.

7. The connector of claim 1 further comprising a permanent adhesive coupling the first upper region with the second upper region.

8. The connector of claim 1 wherein the first and second flexible members are configured so that application of the normal force causes the first intermediate region to separate from the second intermediate region.
